(19) United States
(12) Patent Application Publication
(10) Pub. No.: US 2016/0334639 A1
(43) Pub. Date: Nov. 17, 2016

(54) Modular Eyeglasses Assembly

(71) Applicant: Ross McMillian, Redford, MI (US)

(72) Inventor: Ross McMillian, Redford, MI (US)

(21) Appl. No.: 14/712,578

(22) Filed: May 14, 2015

(51) Int. Cl. G02C 5/14; G02C 5/02; G02C 1/04

(52) U.S. Cl. CPC G02C 5/146; G02C 1/04; G02C 5/02; G02C 2200/08

(57) ABSTRACT

A modular eyeglasses assembly includes a lens frame including a pair of lens receivers. Each of the lens receivers has a lens mounted therein and the lens frame has a pair of lateral ends. The lens frame has a pair of bends therein adjacent to the lateral ends such that the lateral ends are directed rearwardly from the lens frame. A pair of mounts each is attached to one of the terminal ends. Each of a pair of temples is removably attached to one of the mounts. A bridge has an upper surface, a lower surface, a first end and a second end. Each of pair of connectors attaches the lower surface to the lens frame.

### BACKGROUND OF THE DISCLOSURE

### Field of the Disclosure

The disclosure relates to eyeglasses devices and more particularly pertains to a new eyeglasses device for easily allowing a user to change the appearance of a pair of eyeglasses.

### SUMMARY OF THE DISCLOSURE

An embodiment of the disclosure meets the needs presented above by generally comprising a lens frame including a pair of lens receivers. Each of the lens receivers has a lens mounted therein and the lens frame has a pair of lateral ends. The lens frame has a pair of bends therein adjacent to the lateral ends such that the lateral ends are directed rearwardly from the lens frame. A pair of mounts each is attached to one of the terminal ends. Each of a pair of temples is removably attached to one of the mounts. A bridge has an upper surface, a lower surface, a first end and a second end. Each of pair of connectors attaches the lower surface to the lens frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a modular eyeglasses assembly according to an embodiment of the disclosure.

FIG. 2 is an exploded front perspective view of an embodiment of the disclosure.

FIG. 3 is a side view of an embodiment of the disclosure.

FIG. 4 is a cross-sectional view of an embodiment of the disclosure taken along line 4-4 of FIG. 1.

FIG. 5 is a front view of an embodiment of the disclosure including a broken portion of a bridge.

### DESCRIPTION OF THE PREFERRED EMBODIMENT

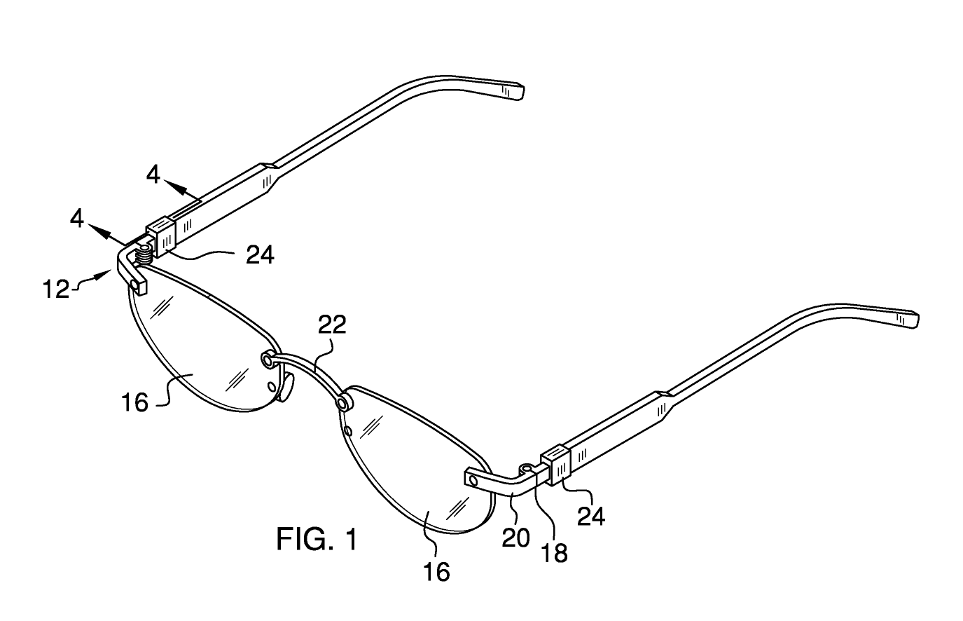

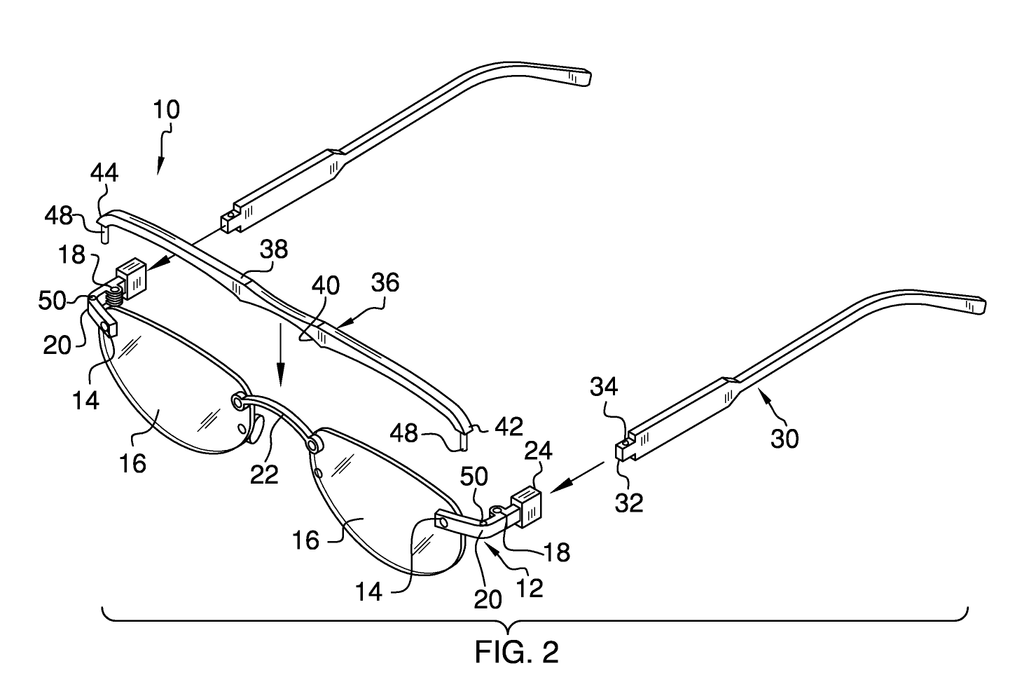

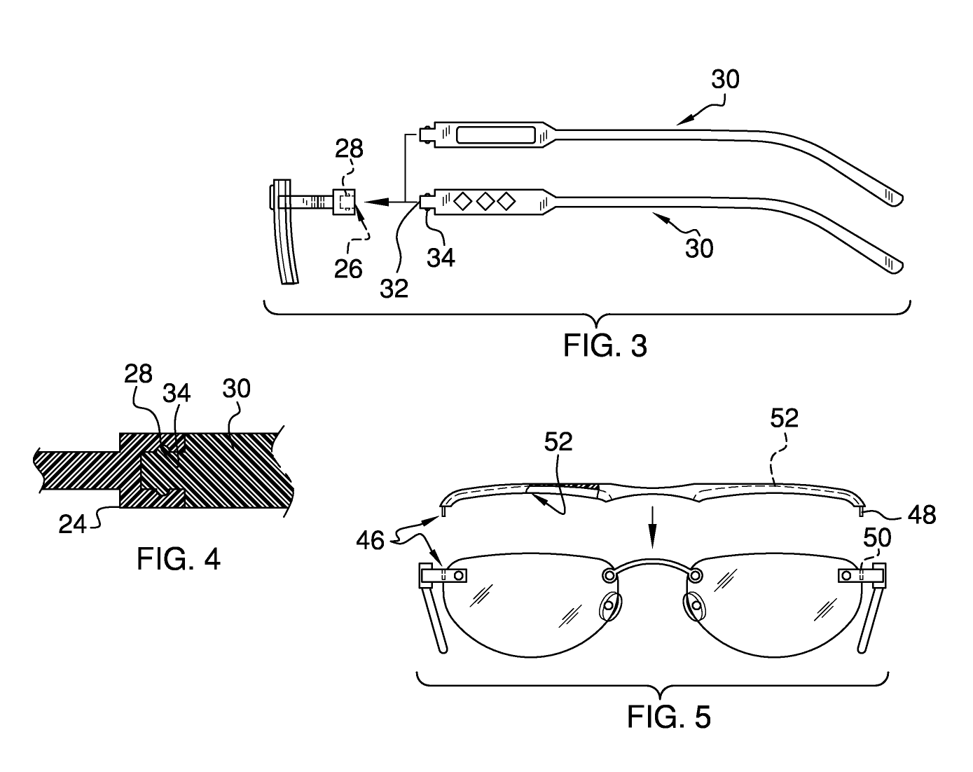

With reference now to the drawings, and in particular to FIGS. 1 through 5 thereof, a new eyeglasses device embodying the principles and concepts of an embodiment of the disclosure and generally designated by the reference numeral 10 will be described.

As best illustrated in FIGS. 1 through 5, the modular eyeglasses assembly 10 generally comprises a lens frame 12 including a pair of lens receivers 14. The lens receivers 14 may comprise any conventional mechanical attachment between the frame and lenses such as being fasteners engaging lenses or loops, or partial loops, that receive lenses. Each of the lens receivers 14 has a lens 16 mounted therein. The lenses 16 may comprise any conventional lens including those such as prescription lenses, reading lenses and/or tinted lenses. The lens frame 12 has a pair of lateral ends 18. The lens frame 12 has a pair of bends 20 therein adjacent to the lateral ends 18 such that the lateral ends 18 are directed rearwardly from the lens frame 12. A nose bar 22 may be extended between the lens receivers 14.

A pair of mounts 24 is provided. Each of the mounts 24 is hingedly coupled to one of the lateral ends 18. The mounts 24 may each include a receiver opening 26. The receiver opening 26 may include friction enhancing members 28 such as indents or detents. A pair of temples 30 is also provided. Each of the temples 30 has a male end 32 that is removably extendable into and secured to one of the mounts 24. The male ends 32 include mating members 34 for engaging the friction enhancing members 28 and may comprise a snap fitting. The temples 30 may include a plurality of pairs of temples 30 each of which has a different color or aesthetic appearance. Thus the user of the assembly 10 can alter the appearance of the assembly 10 as needed by changing the temples 30 as needed.

A bridge 36 is provided that has an upper surface 38, a lower surface 40, a first end 42 and a second end 44. A pair of connectors 46 is provided. Each of the connectors 46 attaches the lower surface 40 to the lens frame 12. Each of the connectors 46 includes a male coupler 48 and a female coupler 50. Each male coupler 48 of the connectors 46 is attached to the lower surface 40. The male couplers 48 are positioned such that one male coupler is positioned adjacent to each of the first 42 and second 44 ends. Each female coupler 50 of the connectors 46 extends into the lens frame 12 and comprises a well for receiving the male couplers 48 which may comprise a pin. Each of the terminal ends 18 has one of the female couplers 50 positioned adjacent thereto. As with the temples 30, the bridge 36 will be provided in a plurality of colors and designs such that they may, or may not, be matched to the temples 30, but still allow the user of the assembly 10 to alter the appearance of the assembly 10. The lower surface 40 may include a contoured area which contours to nose bar 22 as is shown in FIG. 5. Further, the lower surface may include slots 52 for receiving the lenses 16. The slots 52 may serve as the connectors 46 if they sufficiently frictionally engage the lenses 16 or portions of the lens frame 12.

In use, the assembly 10 is worn as a pair of conventional eyeglasses. However, the bridge 36 and the temples 30 may be removed and replaced as desired to alter the look of the eyeglasses.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A modular eyeglasses assembly comprising:
a lens frame including a pair of lens receivers, each of said lens receivers having a lens mounted therein, said lens frame having a pair of lateral ends, said lens frame having a pair of bends therein adjacent to said lateral ends such that said lateral ends are directed rearwardly from said lens frame;
a pair of mounts each being attached to one of said lateral ends, each of said mounts being hingedly coupled to one of said lateral ends, each of said mounts includes a receiver opening;
a pair of temples, each of said temples being removably attached to one of said mounts, each of said temples having a male end, said male end of each temple being extendable into and secured to an associated one of said mounts, said male end of each of said temples being removable from said associated one of said mounts wherein said temples are replaceable;
a bridge, said bridge being separate from said temples, said bridge having an upper surface, a lower surface, a first end and a second end; and
a pair of connectors, each of said connectors attaching said lower surface to said lens frame.

2. (canceled)

3. (canceled)

4. The modular eyeglasses assembly according to claim 1, wherein each of said connectors including a male coupler and a female coupler, each said male coupler of said connectors being attached to said lower surface, each of said male couplers being positioned adjacent to one of said first and second ends, each said female coupler of said connectors extending into said lens frame, each of said lateral ends having one of said female couplers positioned adjacent thereto.

5. A modular eyeglasses assembly comprising:
a lens frame including a pair of lens receivers, each of said lens receivers having a lens mounted therein, said lens frame having a pair of lateral ends, said lens frame having a pair of bends therein adjacent to said lateral ends such that said lateral ends are directed rearwardly from said lens frame;
a pair of mounts, each of said mounts being hingedly coupled to one of said lateral ends, each of said mounts including a receiver opening;
a pair of temples, each of said temples having a male end, said male end of each temple being extendable into and secured to an associated one of said mounts, said male end of each of said temples being removable from said associated one of said mounts wherein said temples are replaceable;
a bridge, said bridge being separate from said temples, said bridge having an upper surface, a lower surface, a first end and a second end; and
a pair of connectors, each of said connectors attaching said lower surface to said lens frame, each of said connectors including a male coupler and a female coupler, each said male coupler of said connectors being attached to said lower surface, each of said male couplers being positioned adjacent to one of said first and second ends, each said female coupler of said connectors extending into said lens frame, each of said lateral ends having one of said female couplers positioned adjacent thereto.
